(19) United States
(12) Patent Application Publication
(10) Pub. No.: US 2017/0212987 A1
(43) Pub. Date: Jul. 27, 2017

(54) SYSTEM AND DEVICE FOR USE WITH MEDICAL IMAGING

(71) Applicant: Imaging Advantage, Phoenix, AZ (US)

(72) Inventors: Kamil Rahme, Phoenix, AZ (US); Jordan Kojouharov, Scotsdale, AZ (US)

(73) Assignee: Imaging Advantage, Phoenix, AZ (US)

(21) Appl. No.: 15/416,746

(22) Filed: Jan. 26, 2017

Related U.S. Application Data
(60) Provisional application No. 62/287,237, filed on Jan. 26, 2016.

(51) Int. Cl. G06F 19/00

(52) U.S. Cl. CPC G06F 19/321; G06F 19/322

(57) ABSTRACT

According to some embodiments of the invention, improved systems and devices for use with medical imaging are provided. According to some embodiments of the invention, a medical imaging record (e.g., an EMR) may be received that includes medical imaging (e.g., an X-ray, ultrasound, CT scan, MRI, etc.) generated using a medical imaging device. The medical imaging record may be filtered to remove unnecessary information, such as information not germane to analyzing the medical imaging. The filtered medical imaging record may be transmitted to a radiologist, who may add a radiology report interpreting the medical imaging. The complete data record, including the medical imaging record and the radiology report, may be stored in conjunction with a record identification number.

### CROSS-REFERENCES TO RELATED APPLICATIONS

This application claims the benefit of U.S. Provisional Patent Application No. 62/287,237, filed Jan. 26, 2016, entitled “SYSTEM AND DEVICE FOR USE WITH MEDICAL IMAGING”, and is hereby incorporated by reference in its entirety.

### BACKGROUND OF THE INVENTION

Medical facilities, including hospitals and clinics, implement a variety of medical imaging systems, such as X-rays, CTs, MRIs, ultrasounds, and the like, to create medical images of patients. These medical images may be combined with patient information (e.g., name, date of birth, historical medical records, etc.) as well as imaging information (e.g., type of imaging, body location of imaging, name and location of medical facility, etc.) to create EMRs (electronic medical records). The EMRs may then be sent to radiologists, who may analyze and interpret the medical images. The radiologists may generate a medical imaging report including analysis and information (e.g., diagnoses, findings, conclusions, radiologist name, date and time of diagnoses, comments, etc.) that may be forwarded back to the medical facilities for appropriate treatment of the patients.

Implementing these processes may give rise to a variety of obstacles. For example, medical facilities may store EMRs (electronic medical records) on different systems that often have different protocols. Furthermore, medical imaging that is included in EMRs is often received from a variety of medical imaging systems (e.g., X-rays, CTs, MRIs, etc.) having different manufacturers, models, and years of manufacture. Sharing and distributing EMRs having immense variations creates obstacles to doctors collaborating on patient care. For example, radiologists may need a number and variety of different types of software to receive, interpret and transmit EMRs and medical imaging reports to and from different medical facilities and/or different medical imaging systems. Information deficiency and time lag associated with technological barriers to sharing EMRs can negatively impact patient care and increase cost of care.

### SUMMARY OF THE INVENTION

Thus, according to some embodiments of the invention, improved systems and devices for use with medical imaging are provided. According to some embodiments of the invention, a medical imaging record (e.g., an EMR) may be received that includes medical imaging (e.g., an X-ray, ultrasound, CT scan, MRI, etc.) generated using a medical imaging device. The medical imaging record may be filtered to remove unnecessary information, such as information not germane to analyzing the medical imaging. The filtered medical imaging record may be transmitted to a radiologist, who may add a radiology report interpreting the medical imaging. The complete data record, including the medical imaging record and the radiology report, may be stored in conjunction with a record identifier, such as a record identification number. The complete data record may be stored in a suitable data store, such as a picture archiving and communication system (PACS) and/or a radiology information system (RIS).

According to some embodiments of the invention, a device is provided. The device comprises a processor and a memory coupled to the processor. The memory stores instructions, which when executed by the processor, cause the device to perform operations including receiving a medical imaging record that includes medical imaging data. The medical imaging data was generated using a medical imaging device. The medical imaging record is received from a medical imaging record data store. The operations further include generating a filtered medical imaging record by filtering the medical imaging record according to one or more selected fields. The operations further include formatting the filtered medical imaging record for transmission to a server over a communication channel. The operations further include transmitting the formatted medical imaging record to the server as an imaging package over the communication channel. The imaging package includes the medical imaging data and a record identifier that identifies the medical imaging record. The operations further include receiving a report package from the server. The report package includes the record identifier and a radiology report that includes analysis of the medical imaging data sent in the imaging package. The operations further include writing the radiology report to the medical imaging record data store. Writing the radiology report to the medical imaging record data store includes writing the radiology report to the medical imaging record identified by the record identifier.

According to some embodiments of the invention, a computer-implemented method is provided. The method comprises receiving a medical imaging record that includes medical imaging data, wherein the medical imaging data was generated using a medical imaging device, and wherein the medical imaging record is received from a medical imaging record data store. The method further comprises generating a filtered medical imaging record by filtering the medical imaging record according to one or more selected fields. The method further comprises formatting the filtered medical imaging record for transmission to a server over a communication channel. The method further comprises transmitting the formatted medical imaging record to the server as an imaging package over the communication channel, wherein the imaging package includes the medical imaging data and a record identifier that identifies the medical imaging record. The method further comprises receiving a report package from the server, wherein the report package includes the record identifier and a radiology report that includes analysis of the medical imaging data sent in the imaging package. The method further comprises writing the radiology report to the medical imaging record data store, wherein writing the radiology report to the medical imaging record data store includes writing the radiology report to the medical imaging record identified by the record identifier.

According to some embodiments of the invention, a computer-program product tangibly embodied in a non-transitory machine-readable storage medium of a computing device is provided. The non-transitory machine-readable storage medium includes instructions that, when executed by one or more processors, cause the one or more processors to receive a medical imaging record that includes medical imaging data, wherein the medical imaging data was generated using a medical imaging device, and wherein the medical imaging record is received from a medical imaging record data store; generate a filtered medical imaging record by filtering the medical imaging record according to one or more selected fields; format the filtered medical imaging record for transmission to a server over a communication channel; transmit the formatted medical imaging record to the server as an imaging package over the communication channel, wherein the imaging package includes the medical imaging data and a record identifier that identifies the medical imaging record; receive a report package from the server, wherein the report package includes the record identifier and a radiology report that includes analysis of the medical imaging data sent in the imaging package; and write the radiology report to the medical imaging record data store, wherein writing the radiology report to the medical imaging record data store includes writing the radiology report to the medical imaging record identified by the record identifier.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present invention are described in detail below with reference to the following drawing figures:

FIG. 1 is a system diagram illustrating a medical imaging distribution system according to some embodiments of the invention.

FIG. 2 is a system diagram illustrating a medical imaging report distribution system according to some embodiments of the invention.

FIG. 3 is a system diagram illustrating an imaging selection device according to some embodiments of the invention.

FIG. 4 is a flow chart illustrating a high level medical imaging report collection and distribution method according to some embodiments of the invention.

FIG. 5 is a flow chart illustrating a medical imaging report distribution method according to some embodiments of the invention.

FIG. 6 is an architectural diagram illustrating the functional layers of a medical imaging report distribution system according to some embodiments of the invention.

### DETAILED DESCRIPTION OF THE INVENTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

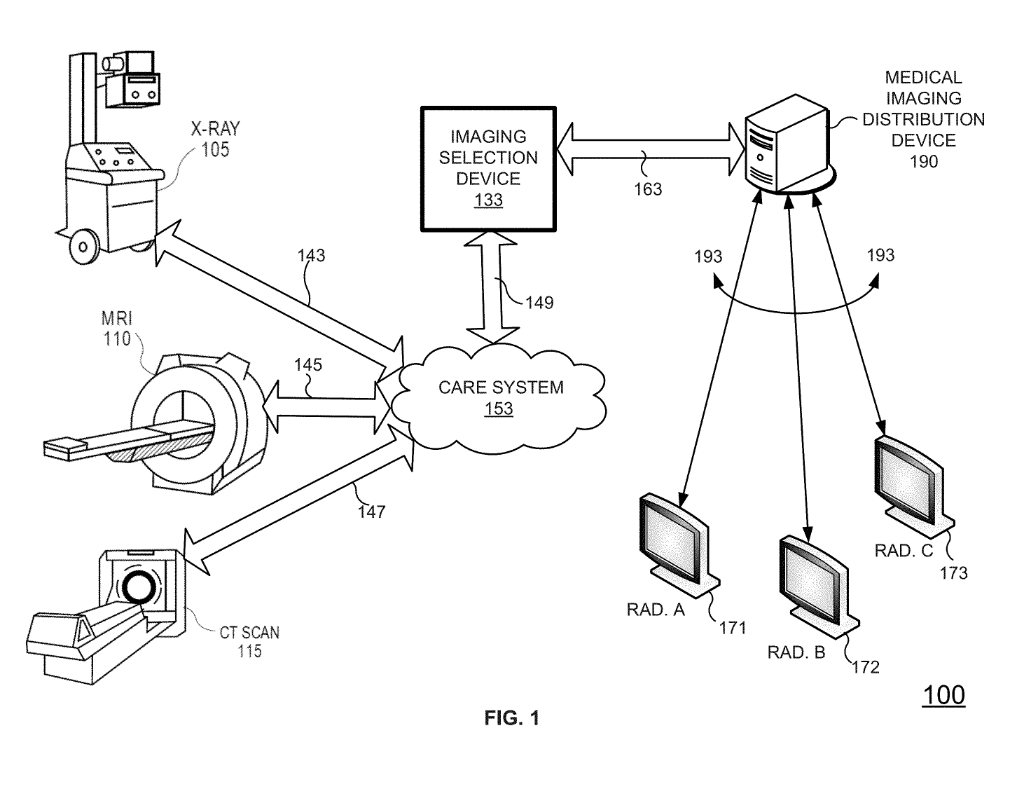

FIG. 1 illustrates a system 100 for distributing EMRs (electronic medical records) that include medical imaging. System 100 includes medical imaging devices. The medical imaging devices may include, but are not limited to, X-ray device 105, MRI device 110, and CT scan device 115. Other types of medical imaging devices (not shown) include ultrasound devices, endoscopy devices, elastography devices, tactile imaging devices, thermography devices, medical photography devices, nuclear medicine functional imaging devices (e.g., positron emission tomography (PET) devices, single-photo emission computed tomography (SPECT) devices, etc.), and/or the like. System 100 also includes care system 153, imaging selection device 133, medical imaging distribution device 190, and radiology terminals 171, 172, and 173.

In the illustrated embodiment, X-ray device 105 is networked to care system 153 via link 143. Similarly, MRI device 110 is networked to care system 153 via link 145 and CT scan device 115 is networked to care system 153 via link 147. Links 143, 145, 147 may include Ethernet connections, wireless connections, or any other suitable network and/or networking protocol. For example, links 143, 145, 147 may be implemented as part of a personal area network (PAN), a local area network (LAN), a metropolitan area network (MAN), a wide area network (WAN), a storage area network (SAN), an enterprise private network (EPN), a virtual private network (VPN), and/or the like. Links 143, 145, 147 may represent communication via any suitable network protocol, such as WiFi/WiMAX, Bluetooth, fibre channel network protocols, TCP/IP, OSI, SSH, SMB, FTP, SMTP, HTTP, HTTPs, SSL, SFTP, and/or the like.

Care system 153 may include a networked datastore suitable to store EMRs, medical imaging, patient information, and the like, such as network-attached storage (NAS) or the like. Care system 153 may include, for example, EMR storage, a Picture Archiving and Communication System (PACS), a Radiology Information System (RIS), and/or the like. In some embodiments, care system 153 is a data storage server connected to a network that provides access to EMRs and other records by clients, such as medical facilities, doctors, patients, caregivers, and/or radiologists. Care system 153 may provide access to EMRs and other records using network file sharing protocols such as Network File System (NFS) protocol, Server Message Block (SMB)/Common Internet File System (CIFS) protocol, and/or Apple Filing Protocol (AFP). Care system 153 may include redundant memory backups to ensure the integrity of the EMRs. The networked datastore may have Terabytes of storage, for example. Care system 153 may include, for example, primary storage, secondary storage, tertiary storage, and/or offline storage. Care system 153 may further include processors, in some embodiments.

Imaging selection device 133 is configured to access care system 153 and medical imaging stored in care system 153. Imaging selection device 133 is configured to read EMRs stored in care system 153 as well as write to EMRs stored in care system 153 via link 149. Link 149 may include Ethernet connections, wireless connections, or other suitable networking protocol that facilitates read and/or write access to the particular care system 153.

X-ray device 105, MM device 110, CT scan device 115, care system 153, and imaging selection device 133 may all be included in a same medical facility such as a hospital or clinic. Alternatively, the medical imaging devices may be in use at more than one clinic while care system 153 is not co-located at the same physical site of the medical imaging devices. In other words, care system 153 may be located locally or remotely with respect to a medical facility. Thus, it is contemplated that more than one care system 153 may be implemented in some embodiments.

Imaging selection device 133 is configured to access medical imaging files within care system 153 as well as certain medical data that is germane to analyzing medical imaging. Some medical data that is included in EMRs stored in care system 153 is not germane to medical imaging files. For example, a patient's social security number is not necessarily useful in analyzing medical imaging. Imaging selection device 133 sends medical imaging files and other relevant medical data that is relevant to analyzing medical imaging to medical imaging distribution device 190, via link 163. Medical imaging distribution device 190 may be a cloud server physically located at a datacenter in some embodiments. System 100 may include more than one distribution device 190 that are stored in different regional locales, for example. Imaging selection device 133 may access the distribution device 190 that is within closest physical proximity to the imaging selection device 133 in some embodiments. In some embodiments, imaging selection device 133 may select a distribution device 190 according to some other criteria, such as network traffic at particular distribution devices 190.

Distribution device 190 receives the medical images and other relevant medical data and generates a task to be put into a task list. The task includes the medical images and other medical data that would be useful in analyzing the medical images and generating a radiology report. The task is assigned to a radiologist and then transferred to the device/system (e.g. 171, 172, or 173) used by the assigned radiologist via one of network links 193. The server may assign the task to a certain radiologist based on radiology specialty (e.g., neurology, oncology, etc.), radiologist availability, a number of tasks already in a radiologist queue, or a variety of other factors.

The assigned radiologist will generate a report based on viewing the medical images and corresponding relevant medical data and send the report back to distribution device 190, via link 193. Distribution device 190 transmits the report back to imaging selection device 133. The report may be in a designated (e.g., standardized) format for efficient processing by imaging selection device 133. Imaging selection device 133 stores the report in care system 153 so that it is accessible for health care providers, facilities, caregivers, patients, etc., that may have access to care system 153.

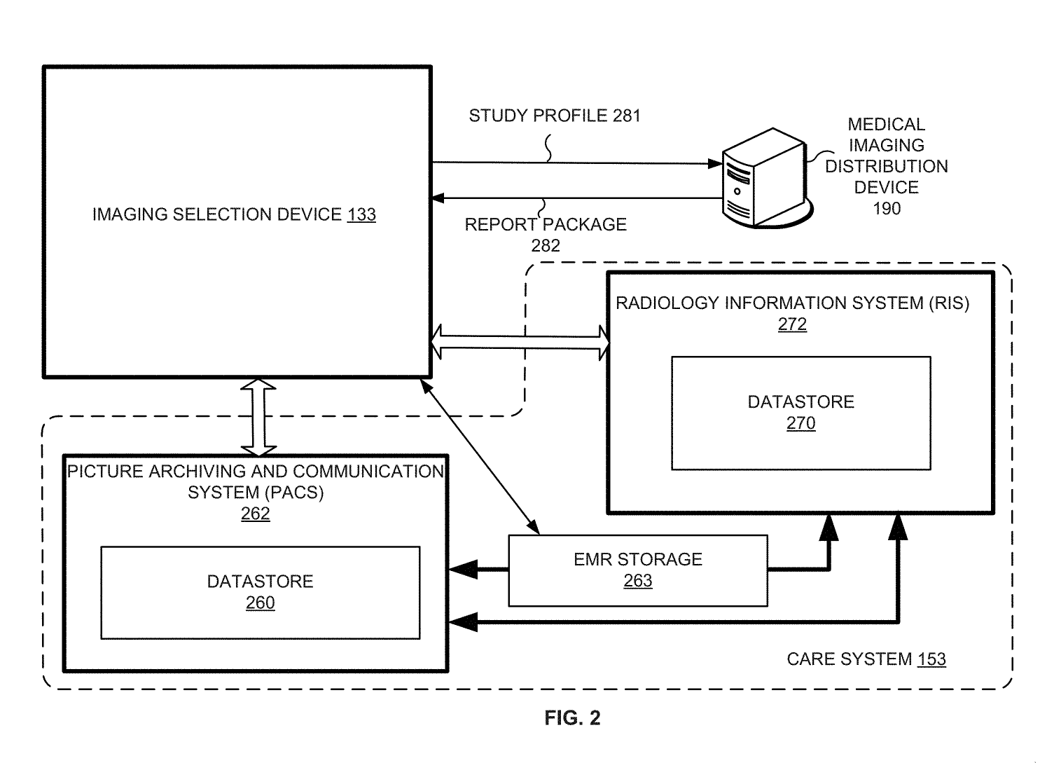

FIG. 2 illustrates a system for distributing medical imaging records (e.g., medical images, EMRs, etc.) that include medical imaging. The system includes an exemplary imaging selection device 133 in communication with a medical imaging distribution device 190 (also referred to herein as a “hub”). The system also includes care system 153. Care system 153 may include, for example, a Picture Archiving and Communication Systems (PACS), EMR storage 263, and/or a Radiology Information System (RIS) 272. As appreciated by one skilled in the art, one, none or multiple of each of these components may exist in care system 153. For example, there may be one RIS 272 per medical imaging device (e.g., X-ray device, MRI device, etc.) at a given medical imaging facility, one PACS 262 per medical imaging facility, and one remote EMR storage 263 located in the cloud.

In use, the imaging selection device 133 may receive medical imaging for a patient from a RIS 272 of a particular medical imaging device, and/or from PACS 262 of a particular medical imaging facility. The medical imaging may be stored in datastore 260 of PACS 262 and/or datastore 270 of MS 272. In another example, the imaging selection device 133 may receive medical imaging for a patient as part of an EMR stored in EMR storage 263. In some embodiments, PACS 262 and RIS 272 may have access to one another by a link to augment the respective medical records utilizing data from the other system.

In response to receiving medical imaging for a patient, the imaging selection device 133 may request additional medical records from PACS 262, RIS 272, and/or EMR storage 263 that are relevant to the medical imaging to create a full study profile for the patient. The full study profile may include the initially received medical imaging and/or some or all of the additional medical records. For example, if the medical imaging received is for a left knee of a patient, the imaging selection device 133 may request all previous medical imaging made of the left knee of the patient in the patient's history, as well as any other relevant information (e.g., prior diagnoses, prior surgeries, prescribed medications, physical therapy records, etc.). The additional medical records may be retrieved by using one or more identifiers included in the initially received medical imaging, such as a patient's name, a patient's date of birth, a patient identification number, and/or the like.

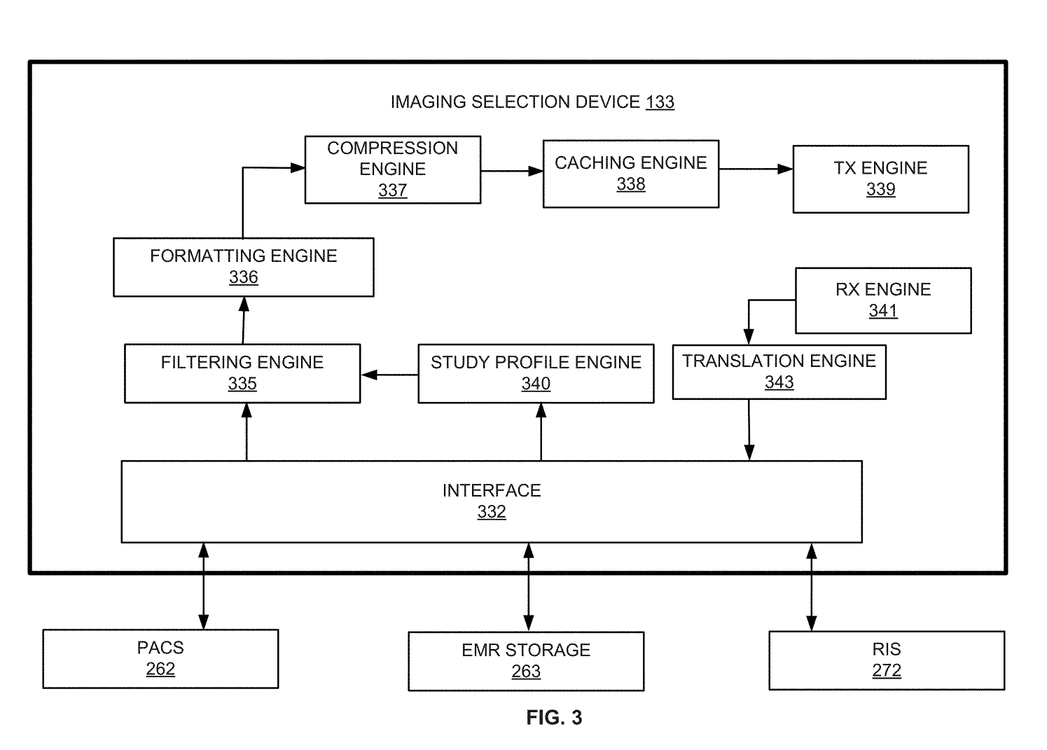

The imaging selection device 133 may then filter and format the study profile as described further with respect to FIG. 3. The imaging selection device 133 may transmit the study profile 281 to the medical imaging distribution device 190. As described herein with respect to FIG. 1, the medical imaging distribution device 190 may receive the study profile 281 and generate a task to be put into a task list. The task may include the study profile 281. The task is assigned to a radiologist and then transferred to the device (e.g., 171, 172, and/or 173) used by the assigned radiologist via one of network links 193, as shown in FIG. 1. The assigned radiologist may generate a report based on viewing the medical images included in the task and send a report package 282 back to distribution device 190. Distribution device 190 may transmit report package 282 back to imaging selection device 133. Report package 282 may include an identifier that identifies the patient or file that the imaging package originates from (e.g., a patient or record identification number, a patient name, a patient date of birth, and/or the like). The report package 282 may be in a designated format for efficient processing by imaging selection device 233, such as a standardized format. The report package 282 may be translated into a storing format that can be written back to the care system 153. Writing the translated report to the care system 153 may include accessing the identifier so that the correct patient's EMR can be updated with the report from the radiologist. The identifier may be any combination of letters, numbers, graphics, and/or symbols.

Imaging selection device 133, the components of care system 153, and/or medical imaging distribution device 190 may use any suitable number of subsystems to facilitate the functions described herein. Such subsystems or components may be interconnected via a system bus. Subsystems may include a printer, keyboard, fixed disk (or other memory comprising computer readable media), display, which may be coupled to a display adapter, and others. Peripherals and input/output (I/O) devices, which may couple to an I/O controller, can be connected to the imaging selection device 133, the components of care system 153, and/or medical imaging distribution device 190 by any number of means. For example, an external interface can be used to connect the imaging selection device 133, the components of care system 153, and/or medical imaging distribution device 190 to a WAN such as the Internet, input device, or a scanner. The interconnection via the system bus may allow the central processor to communicate with each subsystem and to control the execution of instructions from system memory or the fixed disk, as well as the exchange of information between subsystems. The system memory and/or the fixed disk may embody a computer-readable medium.

The functions of imaging selection device 133, the components of care system 153, and/or medical imaging distribution device 190 described herein may be implemented as software code to be executed by a processor using any suitable computer language such as, for example, Java, C++, or Perl, using, for example, conventional or object-oriented techniques. The software code may be stored as a series of instructions or commands on a computer-readable medium, such as a random access memory (RAM), a read only memory (ROM), a magnetic medium such as a hard drive or a floppy disk, and/or an optical medium such as a CD-ROM. The computer readable medium may be any combination of such storage or transmission devices.

Such programs may also be encoded and transmitted using carrier signals adapted for transmission via wired, optical and/or wireless networks conforming to a variety of protocols, including the Internet. As such, a computer-readable medium according to an embodiment of the present invention may be created using a data signal encoded with such programs. Computer-readable media encoded with the program code may be packaged with a compatible device or provided separately from other devices (e.g., via Internet download). Any such computer-readable medium may reside on or within a single computer product (e.g., a hard drive a CD, or an entire computer system), and may be present on or within different computer products within a system or network. The system may include a display for providing any of the results described herein to a user.

FIG. 3 is a system diagram illustrating the details of an imaging selection device 133. Imaging selection device 133 may be communicatively coupled to PACS 262, EMR storage 263, and/or RIS 272. Imaging selection device 133 may include an interface 332, a filtering engine 335, a formatting engine 336, a compression engine 337, a caching engine 338, a study profile engine 340, a translation engine 343, a transmission engine 339, and a receiving engine 341. Imaging selection device 133 may include a processor, microprocessor, FPGA, or other suitable logic device. Imaging selection device 133 also includes suitable networking hardware (e.g., Ethernet card or 802.11 WiFi card) to interface with distribution device 190, PACS 262, EMR storage 263, and/or RIS 272. The networking hardware may interface with a processor of imaging selection device 133 over a PCI (Peripheral Component Interface) bus. Interface 332 may interface with PACS 262, EMR storage 263, and/or RIS 272 to access medical imaging records (e.g., EMRs, medical imaging, other medical records, etc.) that are stored on one or more data stores. Interface 332 may utilize an Application Programming Interface (API) that is specific to PACS 262 to interact with PACS 262 to access the medical imaging files stored as part of the PACS system. Similarly, interface 332 may utilize an EPI that is specific to EMR storage 263 to access the EMRs stored therein. Similarly, interface 332 may utilize an API that is specific to RIS 272 to interact with RIS 272 to access the medical imaging files stored as part of the RIS system. The medical imaging records may be stored in a local memory included in imaging selection device 133 in some embodiments.

Interface 332 may have access to one or more of PACS 262, EMR storage 263, and/or RIS 272, depending on the specific medical record file configuration of the particular health care facility or organization. Some health care facilities utilize a PACS-centric system where PACS is the prominent medical record system and interactions with the medical record system utilize a PACS interface. Other health care facilities utilize a RIS-centric system where RIS is the prominent medical record system and interactions with the medical system utilize a MS interface.

Once interface 332 accesses the relevant medical imaging, the EMR is filtered by filtering engine 335. In addition, interface 332 may request additional medical records relevant to the medical imaging from PACS 262, EMR storage 263, and/or RIS 272, as described further herein with respect to FIG. 2, using study profile engine 340. The study profile may also be passed to the filtering engine 335. Filtering engine 335 may filter the study profile by removing medical data that is not relevant to analyzing medical imaging and need not be included in study profile 281. A patient's social security number, emergency contact information, payment information, and other data items included in an EMR may not necessarily be useful in analyzing medical imaging, for example. However, a patient's age and/or past medical events (e.g. surgeries) may be relevant to analyzing medical imaging, and therefore may be included in study profile 281 for sending to medical imaging distribution device 190. Study profile 281 may include a record identifier that identifies the patient or file that the imaging package originates from.

After filtering engine 335, the filtered data from the relevant EMR may proceed to formatting engine 336. Formatting engine 336 may normalize and/or standardize the filtered data by ordering the filtered data into an efficient format of study profile 281. After formatting engine 336, the medical imaging may be compressed for transmission by compression engine 337. The compression may be lossless compression, in one embodiment. Possible compression modes include JPLL (JPEG lossless), JLSL (JPEG-LS Lossless), J2KR (JPEG 2000 Lossless), and JPLY (JPEG Lossy). The compressed study profile may then be cached locally in storage or memory by caching engine 338.

The compressed data proceeds to transmission engine 339 for transmission to medical imaging distribution device 190 as study profile 281. Transmission engine 339 may send study profile 281 as a burst of packets that include the information of study profile 281. Study profile 281 may include the medical imaging (e.g., X-ray, CT scan, MRI scan, etc.) to be analyzed by a radiologist as well as the medical information relevant to analyzing the medical imaging. The study profile 281 is formatted according to a format that is expected by or compatible with medical imaging distribution device 190, such as a standardized format. Study profile 281 may include the medical imaging and EMR data that is related or relevant to analyzing the medical imaging. The medical imaging distribution device 190 may forward the study profile 281 to a radiologist.

The radiologist may then generate a report package 282 as described herein with respect to FIG. 2 and send the report package 282 to the medical imaging distribution device 290. The medical imaging distribution device 190 may then transmit the report package 282 to the imaging selection device 133. The report package 282 may be received by receiving engine 341 of imaging selection device 233. Translation engine 343 may translate the report package 282 into a storing format that can be written back to the care system 153 (e.g., PACS 262, EMR storage 263, and/or RIS 272) of the particular medical facility. Interface 332 may then write the translated report to the care system 153. Writing the translated report to the care system 153 may include accessing the identifier so that the correct patient's EMR can be updated with the report from the radiologist. The identifier may be any combination of letters, numbers, graphics, and/or symbols.

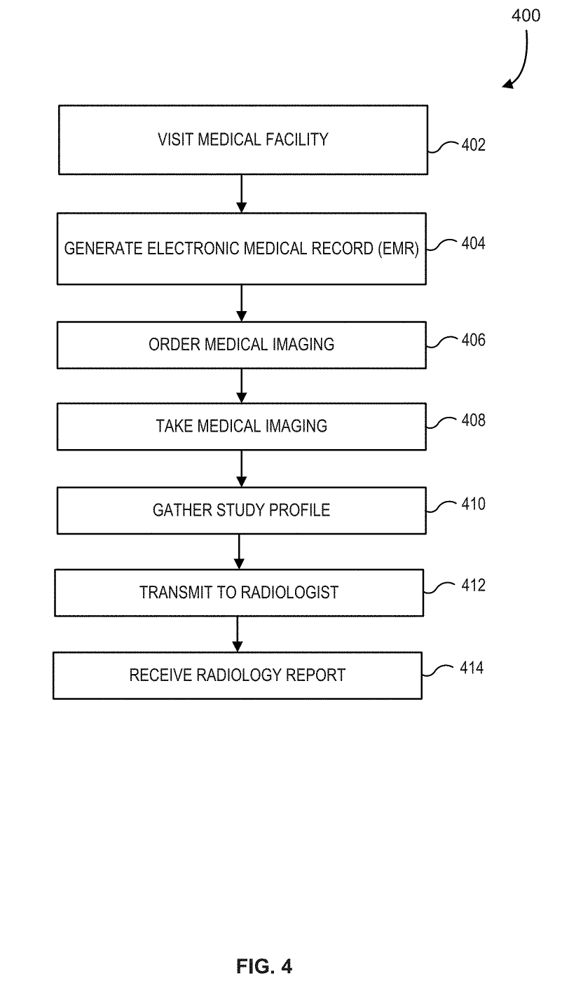

FIG. 4 is a flow chart 400 illustrating a high level medical imaging report collection and distribution method according to some embodiments of the invention. The process is illustrated as a logical flow diagram, each operation of which represents a sequence of operations that can be implemented in either hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Some or all of the process (or any other processes described herein, or variations and/or combinations thereof) may be performed under the control of one or more computer systems configured with executable instructions and may be implemented as code (e.g., executable instructions, one or more computer programs or one or more applications). Network hardware and processing logic of imaging selection device 233 may execute the process blocks show in process 300, for example. The code may be stored on a computer-readable storage medium, for example, in the form of a computer program including a plurality of instructions executable by one or more processors. The computer-readable storage medium may be non-transitory.

At process block 402, a patient visits a medical facility. For example, a patient may visit an orthopedic practice for a sports injury. At process block 404, an EMR is generated for the patient. The EMR may relate to the specific injury or ailment of the patient. At process block 406, medical imaging is ordered. For example, if the patient present symptoms consistent with a broken ankle, an X-ray of the ankle may be ordered.

At process block 408, the medical imaging is taken at a medical imaging facility and transmitted to an imaging selection device, such as imaging selection device 133 described herein. At process block 410, the imaging selection device gathers a study profile relevant to the patient, relevant to the specific injury or ailment of the patient, and/or relevant to the medical imaging. For example, the imaging selection device may search other EMRs previously generated for the patient for similar injuries or ailments that may be relevant to the current injury or ailment.

At process block 412, the study profile is transmitted to the radiologist. The radiologist may analyze and interpret the medical imaging in light of the study profile. The radiologist may then generate a radiology report with his or her interpretation of the medical imaging and/or diagnoses. At process block 414, the radiology report is received from the radiologist.

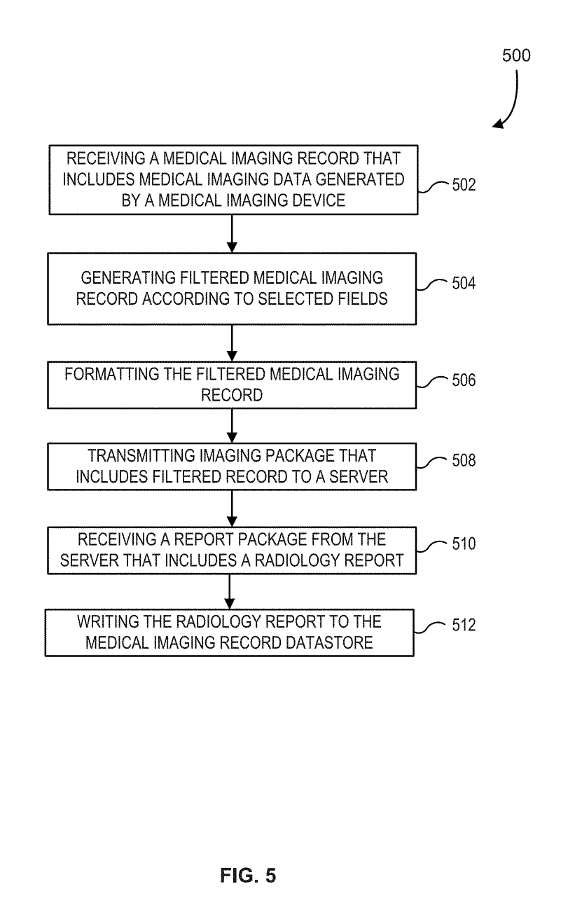

FIG. 5 depicts an illustrative flow chart 500 for a process for generating an imaging package for analysis by a radiologist and writing a report generated by the radiologist to a medical imaging record data store. The process is illustrated as a logical flow diagram, each operation of which represents a sequence of operations that can be implemented in either hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Some or all of the process (or any other processes described herein, or variations and/or combinations thereof) may be performed under the control of one or more computer systems configured with executable instructions and may be implemented as code (e.g., executable instructions, one or more computer programs or one or more applications). Network hardware and processing logic of imaging selection device 233 may execute the process blocks show in process 300, for example. The code may be stored on a computer-readable storage medium, for example, in the form of a computer program including a plurality of instructions executable by one or more processors. The computer-readable storage medium may be non-transitory.

In process block 502, a medical imaging record that includes medical imaging data is received. The medical imaging data is generated by a medical imaging device (e.g., X-ray device 105, MRI device 110, CT scan device 115, etc.). The medical imaging record may be received from a medical imaging record data store, such as data store 260, 263, 270, or a combination of data store 260, 263 and 270. A study profile may be generated including the medical imaging record and/or additional medical information relevant to the medical imaging record, as described further herein.

In process block 504, the study profile may be filtered according to selected fields. For example, certain selected fields that are not relevant to analyzing medical imaging may be removed from the study profile. In one embodiment, a patient's social security number, emergency contact information, and payment information are removed from the study profile. The filtered study profile generated by process block 504 may be formatted into a formatted study profile to be sent as an imaging package (e.g., study profile 281), in process block 506. The study profile 281 may be formatted according to a format that is expected by or compatible with medical imaging distribution device 190 and/or standardized. In some embodiments, the process may also include compressing the study profile prior to transmission. The compression may be lossless compression, in one embodiment. The filtered study profile and the formatted study profile may be temporarily stored in the local storage of imaging selection device 133 prior to transmission to medical imaging distribution device 190. The study profile may be transmitted to a server in process block 508. The study profile may include the entirety of the medical imaging data as well as the selected medical imaging record fields. The study profile may also include an identifier that identifies the study profile that was originally received from the medical imaging record data store. In one embodiment, imaging selection device '33 may generate the identifier.

In process block 510, a report package may be received from the server. The report package (e.g. study profile 282) may include a radiology report that includes analysis of the medical imaging data. The report package may also include the record identifier. In process block 512, the radiology report may be written to the medical imaging record data store. In one embodiment, imaging selection device 133 may use the identifier received in the report package to identify and write to the correct medical imaging record on the medical imaging record data store with the radiology report.

Filtering the study profile fields in process block 504 to fields that are relevant to analyzing medical imaging and formatting the medical imaging record for transmission to distribution device 190 in process block 506 may increase the efficiency and speed of transferring study profile 281 to medical imaging distribution device 190. The processing burden of medical imaging distribution device 190 may also be reduced, which ultimately can reduce the time required to distribute the task to radiologists, have the medical imaging analyzed, and have a report generated for actionable patient care. This filtering and formatting may be especially important for the developing world, rural areas, or other locales that are otherwise constrained by electronic communication speed.

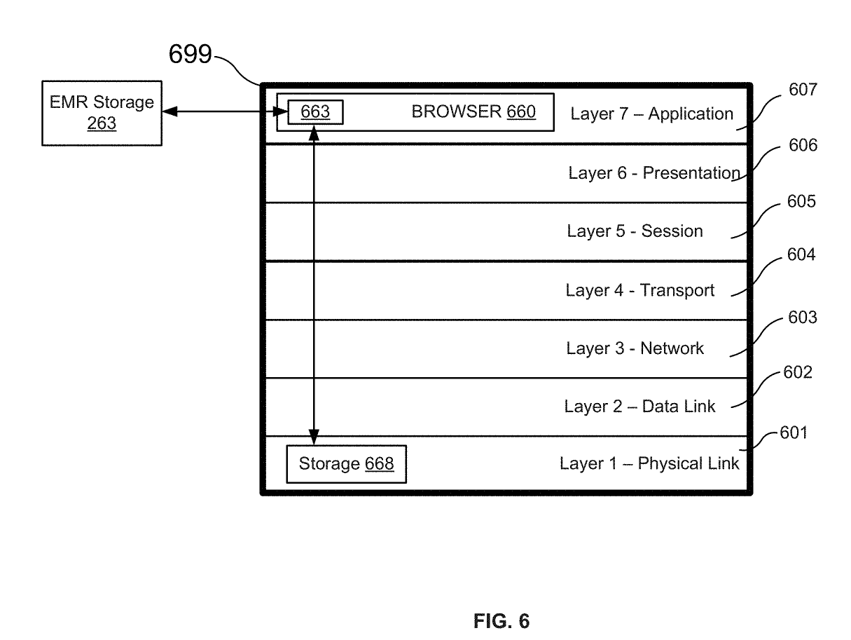

FIG. 6 is a block diagram of a protocol stack 699 that may be implemented by imaging selection device 133 in accordance with some embodiments. The imaging selection device 133 may implement the protocol stack to communicate with any of the other systems described herein. The protocol stack 699 may include one or more of seven layers: an application layer 607, a presentation layer 606, a session layer 605, a transport layer 604, a network layer 603, a data link layer 602, and a physical link layer 601. Together, these seven layers may represent a model, such as an Open Systems Interconnection (OSI) model. The OSI model of FIG. 6 may characterize the communication functions of the described systems. Although shown and described as having seven layers, it is contemplated that the protocol stack 699 may include more or fewer layers to perform less, the same, or additional functions.

According to the OSI model, the application layer 607 may interact with a user (e.g., via receiving user inputs and presenting outputs) and software applications implementing a communication component. The application layer 607 may synchronize communication between systems and determine resource availability. The application layer 607 may be application-specific, in that the specific functions dependent on the particular application being executed by the computing device.

For example, the application layer 607 may execute a browser 660 (e.g., Google Chrome) which in turn may execute the processes (e.g., of flowchart 500) of the disclosure with the assistance of an extension 663. Browser 660 and extension 663 may be executed entirely at the application layer 607. This allows for radiologists to receive and view medical imaging records (e.g., from EMR storage 263, PACS 262 (not shown), and/or RIS 272 (not shown)), and complete and transmit radiology reports in a zero footprint system in that only a browser as an application and corresponding extension are required to execute the disclosed processes. In implementations that include a zero footprint system, any of the records and/or data described herein may be stored in a memory of a server, for example. The browser and corresponding extension may then access this content stored in the memory of the server.

The presentation layer 606 may translate between application and network formats. Various applications and networks may implement different syntaxes and semantics. Thus, the presentation layer 606 may transform data from the network into a form that the application accepts. The presentation layer 606 may also format and encrypt data from the application to be sent on a network.

The session layer 605 may control connections between the systems and other devices and/or servers, as described herein. The session layer 605 may establish the connections, manage the connections, and terminate the connections used to communicate between the devices.

The transport layer 604 may provide techniques for performing quality of service functions during transfers of data between devices. The transport layer 604 may provide error control. For example, the transport layer 404 may keep track of data being transmitted and transmit any communications that fail. In addition, the transport layer 604 may provide an acknowledgment of successful data transmission and send the next data to be transmitted in a synchronous fashion if no errors occurred.

The network layer 603 may provide the means of transferring the data to and from the systems over a network. The source node and destination node of the systems may each have an address which permits the other to transfer data to it by providing the address with the data. The network layer 603 may also perform routing functions that allow it to a determine a path between the source node and destination node, possibly through other nodes.

The data link layer 602 may define and provide the link between a directly and physically connected source node and destination node. The data link layer 602 may further detect and correct errors occurring at the physical link layer 601. In some embodiments, the data link layer 602 may include two sublayers: a media access control (MAC) layer that may control how devices in the network gain access to data and gain permission to transmit it, and a logical link control (LLC) layer that may identify network layer 603 protocols and encapsulate them.

The physical link layer 601 may include one or more storage devices 668. The storage devices 668 may, for example, cache study profiles for transmission, as described further herein. The physical link layer 601 may define the electrical and physical specifications of the data. The physical link layer 601 may provide a physical medium for storing unstructured raw data to be transmitted and received.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. The computer-readable medium may be understood to include one or more computer-readable media of various forms, in various examples.

In the foregoing description, aspects of the application are described with reference to specific embodiments thereof, but those skilled in the art will recognize that the invention is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as performing or being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

What is claimed is:

1. A device comprising:
a processor; and
a memory coupled to the processor, the memory storing instructions which when executed by the processor, cause the device to perform operations including:
receiving a medical imaging record that includes medical imaging data, wherein the medical imaging data was generated using a medical imaging device, and wherein the medical imaging record is received from a medical imaging record datastore;
generating a filtered medical imaging record by filtering the medical imaging record according to one or more selected fields;
formatting the filtered medical imaging record for transmission to a server over a communication channel;
transmitting the formatted medical imaging record to the server as an imaging package over the communication channel, wherein the imaging package includes the medical imaging data and a record identifier that identifies the medical imaging record;
receiving a report package from the server, wherein the report package includes the record identifier and a radiology report that includes analysis of the medical imaging data sent in the imaging package; and
writing the radiology report to the medical imaging record datastore, wherein writing the radiology report to the medical imaging record datastore includes writing the radiology report to the medical imaging record identified by the record identifier.

2. The device of claim 1, wherein generating the filtered medical imaging record includes removing data unrelated to the medical imaging data from the medical imaging record.

3. The device of claim 1, wherein the medical imaging record is an electronic medical record (EMR).

4. The device of claim 1, wherein formatting the filtered medical imaging record includes placing the filtered medical imaging record into a standardized format.

5. The device of claim 1, wherein the record identifier is numerical.

6. The device of claim 1, wherein formatting the filtered medical imaging record includes compressing the filtered medical imaging record.

7. The device of claim 1, wherein the radiology report is received in a standardized format.

8. A computer-implemented method comprising:
receiving a medical imaging record that includes medical imaging data, wherein the medical imaging data was generated using a medical imaging device, and wherein the medical imaging record is received from a medical imaging record datastore;
generating a filtered medical imaging record by filtering the medical imaging record according to one or more selected fields;
formatting the filtered medical imaging record for transmission to a server over a communication channel;
transmitting the formatted medical imaging record to the server as an imaging package over the communication channel, wherein the imaging package includes the medical imaging data and a record identifier that identifies the medical imaging record;
receiving a report package from the server, wherein the report package includes the record identifier and a radiology report that includes analysis of the medical imaging data sent in the imaging package; and
writing the radiology report to the medical imaging record datastore, wherein writing the radiology report to the medical imaging record datastore includes writing the radiology report to the medical imaging record identified by the record identifier.

9. The computer-implemented method of claim 8, wherein generating the filtered medical imaging record includes removing data unrelated to the medical imaging data from the medical imaging record.

10. The computer-implemented method of claim 8, wherein the medical imaging record is an electronic medical record (EMR).

11. The computer-implemented method of claim 8, wherein formatting the filtered medical imaging record includes placing the filtered medical imaging record into a standardized format.

12. The computer-implemented method of claim 8, wherein the record identifier is numerical.

13. The computer-implemented method of claim 8, wherein formatting the filtered medical imaging record includes compressing the filtered medical imaging record.

14. The computer-implemented method of claim 8, wherein the radiology report is received in a standardized format.

15. A computer-program product tangibly embodied in a non-transitory machine-readable storage medium of a computing device, including instructions that, when executed by one or more processors, cause the one or more processors to:
receive a medical imaging record that includes medical imaging data, wherein the medical imaging data was generated using a medical imaging device, and wherein the medical imaging record is received from a medical imaging record datastore;
generate a filtered medical imaging record by filtering the medical imaging record according to one or more selected fields;
format the filtered medical imaging record for transmission to a server over a communication channel;
transmit the formatted medical imaging record to the server as an imaging package over the communication channel, wherein the imaging package includes the medical imaging data and a record identifier that identifies the medical imaging record;
receive a report package from the server, wherein the report package includes the record identifier and a radiology report that includes analysis of the medical imaging data sent in the imaging package; and
write the radiology report to the medical imaging record datastore, wherein writing the radiology report to the medical imaging record datastore includes writing the radiology report to the medical imaging record identified by the record identifier.

16. The computer-program product of claim 15, wherein generating the filtered medical imaging record includes removing data unrelated to the medical imaging data from the medical imaging record.

17. The computer-program product of claim 15, wherein the medical imaging record is an electronic medical record (EMR).

18. The computer-program product of claim 15, wherein formatting the filtered medical imaging record includes placing the filtered medical imaging record into a standardized format.

19. The computer-program product of claim 15, wherein the record identifier is numerical.

20. The computer-program product of claim 15, wherein formatting the filtered medical imaging record includes compressing the filtered medical imaging record.

21. The computer-program product of claim 15, wherein the radiology report is received in a standardized format.
